(19) United States
(12) Patent Application Publication
(10) Pub. No.: US 2018/0297755 A1
(43) Pub. Date: Oct. 18, 2018

(54) Triple Shot Shaker

(71) Applicant: Theodore Olivarez, Jacksonville, FL (US)

(72) Inventors: Theodore Olivarez, Jacksonville, FL (US); Shue Chan, Jacksonville, FL (US)

(21) Appl. No.: 15/875,999

(22) Filed: Jan. 19, 2018

Related U.S. Application Data
(60) Provisional application No. 62/478,527, filed on Mar. 29, 2017.

(51) Int. Cl. B65D 51/28; B65D 47/06; A47J 43/27; B65D 25/56

(52) U.S. Cl. CPC B65D 51/2864; B65D 25/56; A47J 43/27; B65D 47/06

(57) ABSTRACT

Shaker will provide users a quicker and more efficient way to take their supplements before, during, and after their workouts. This delivery system will offer them the option to carry all three main supplements at once.

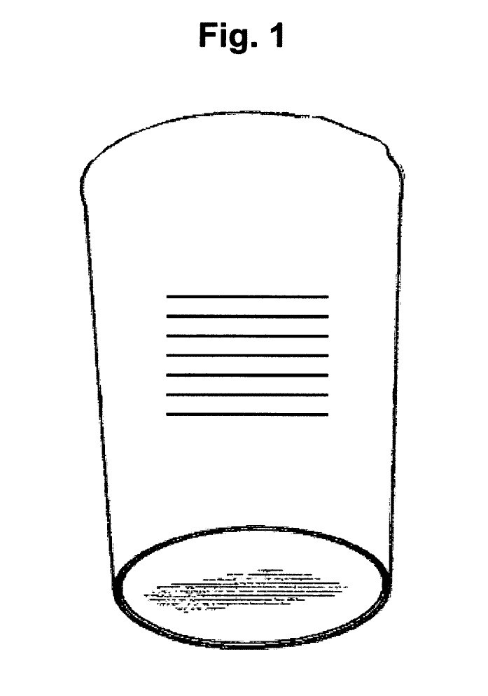

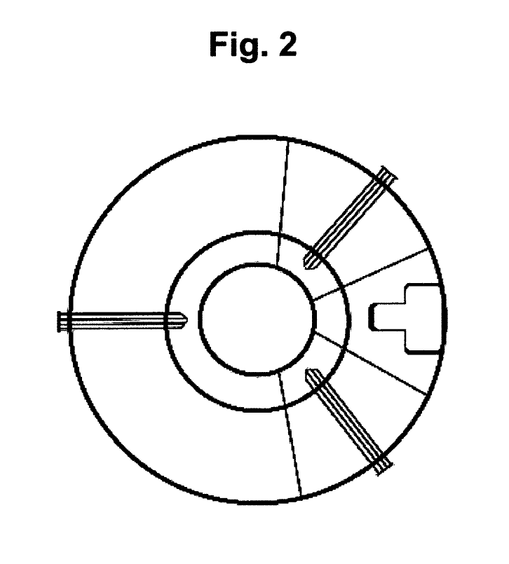

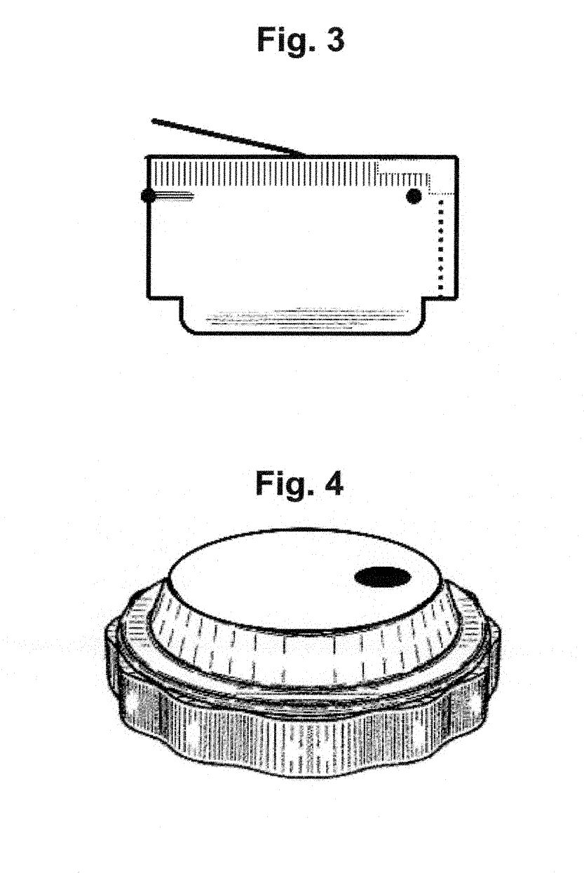

### BACKGROUND

### Field of the Invention

A high quality, premium supplement shaker that provides the athlete with a pre, during, and post workout supplements storage all in one unit. No other shaker offer compartments that allow you to hold and mix supplements within the same unit. This will eliminate the inconvenience of carrying multiple bottles and supplement tubs to the gym. The container seamlessly seals all three compartments and utilizes a simple compartment slider mechanism to release the supplements into the shaker cup as needed. Drinking will be through a spout on the central lid opening.

### Description of the Related Art

The art provided shows the breakdown of the shaker.

### SUMMARY

A three compartment beverage container lid will be divided into a semi circle and two quarters to encompass the supplements that most athletes routinely use. It provides a complete and convenient method of containing pre/during/post workout training supplements in dry form all in one storage area to eliminate the inconvenience of carrying multiple containers. Rather than having to try to scoop it out of a single compartment, our shaker will allow the user to just add all their mixes in the one setting and as they need it, all they will have to do is pull the spring loaded pin to release the power mix of their choice. This will cause the mix to empty into the cup compartment below.

### DESCRIPTION OF THE DRAWINGS

1. Cup Elevation view on ShakerDesign1, is a transparent overview of the shaker

2. Lid Elevation view is a transparent side view of the lid

3. Cup Elevation view is a transparent view of the bottom the shaker

4. Top Lid Section A view is the top closed view of the lid to the shaker

5. Powder Chamber B view is a transparent view of the inside of the lid

6. Pin Chamber C view shows how the pin mechanism will work

7. Bottom of Lid D view shows is a transparent view of the bottom of the shaker lid

8. Break down of the pin mechanics is also included

### DETAILED DESCRIPTION:

Reference is made herein to the attached drawings. The figures are intended for representative purposes only and should not be considered to be limiting in any respect.

Referring now to Plain view, this displays the side of the shaker. There will be markings on the side to allow the user to measure.

Elevation view displays a transparent view from the side. The picture also shows the lid to the top opening and the spout for drinking extending to the bottom of the lid.

Top Lid Section A displays a close up, transparent top view of the lid.

Powder Chamber B, here you can see the three compartments that will store supplements for the user as well as a spout to drink from. The compartments will be open by the slide of the pins also shown in this picture. There is a rubber gasket seal to prevent leaks.

Pin Chamber C displays the pins as mentioned in the above Powder Chamber B, that once activated will allow the supplement to drop into the water below for the user to then shake and mix.

Bottom of Lid D shows a close up of the lid upside down. This shows the spout for the drink to flow through once attached to the shaker.

The user will fill the shaker, lid compartments with the supplements they desire. They will also fill the shaker or lower portion with water. To mix the supplement they desire, the user will simply activate for that compartment causing the dry supplement to fall into the water. The user will no longer need to carry multiple bottles or supplement containers as now it will be housed in one unit.

The above is to be considered as an illustration of the principles of the invention. Since modifications and changes may occur, the drawings are not intended to limit the invention to the exact construction and operation described.

1. (canceled)

2. (canceled)

3. (canceled)

4. (canceled)

5. An apparatus that is used for a mixing powder substance held in the lid with a liquid substance held in the lower cup.

6. A shaker comprising: a lower part housing to hold liquid.

7. A lid comprising: of a multi-compartment housing to store powder. Once the pin is pulled from said lid, the powder will drop into said lower cup.
